(19) United States
(12) Patent Application Publication
(10) Pub. No.: US 2013/0194521 A1
(43) Pub. Date: Aug. 1, 2013

(54) DISPLAY APPARATUS HAVING AUTOSTEREOSCOPIC 3D OR 2D/3D SWITCHABLE PIXEL ARRANGEMENT

(71) Applicants: Sang-Woo Whangbo, Seoul (KR); Myung-Hwan Kim, Hwaseong-si (KR)

(72) Inventors: Sang-Woo Whangbo, Seoul (KR); Myung-Hwan Kim, Hwaseong-si (KR)

(73) Assignee: Samsung Display Co., Ltd., Yongin-si (KR)

(21) Appl. No.: 13/560,484

(22) Filed: Jul. 27, 2012

(30) Foreign Application Priority Data
Jul. 29, 2011 (KR) 10-2011-0075919

(51) Int. Cl. G02B 27/22

(52) U.S. Cl. CPC G02B 27/2214
USPC 349/15

(57) ABSTRACT

An autostereoscopic 3D display apparatus including a display panel having an array of pixels, and a lenticular device positioned above the display panel. The lenticular device includes an array of lenticular components extending in parallel with a line slanted at an angle of tan⁻¹(a/mb) with regard to columns of the pixels, where m refers to the number of adjacent rows before an identical viewpoint on the same line appears, and a and b refer to horizontal and vertical lengths of each pixel. When n is 0 or a natural number, the number of viewpoints is 2m(2n+1), pixels corresponding to the given viewpoints are repeated at every m rows in each lenticular component, the number of parallel lines extending through pixels in parallel with the slant line inside each lenticular component is identical to the number of viewpoints, and each of the parallel lines lies on the repeated pixels.

### CROSS-REFERENCE TO RELATED APPLICATIONS

This application claims priority from and the benefit of Korean Patent Application No. 10-2011-0075919, filed on Jul. 29, 2011, which is hereby incorporated by reference for all purposes as if fully set forth herein.

### BACKGROUND

1. Field

Exemplary embodiments of the present invention relate to a display apparatus having an autostereoscopic 3D or 2D/3D switchable pixel arrangement and, more particularly, to a display apparatus having a pixel arrangement for an autostereoscopic 3D or 2D/3D switchable display which can compensate for luminance degradation.

2. Discussion of the Background

3D (three-dimensional) display technology is classified into stereoscopic display technology, which requires that the observer wear special glasses, such as shutter glasses, to watch 3D images, and autostereoscopic display technology, which requires no special glasses. The stereoscopic display technology requires glasses, which may consist of shutter glasses having liquid crystals for left and right eyes alternately transmitting and blocking light with a predetermined period, respectively, and a device for driving the shutter glasses. That is, images for left and right eyes are separately provided to create the illusion of 3D images. However, stereoscopic display technology has a drawback in that it requires additional devices, including the liquid crystal shutter glasses and their driving device.

The autostereoscopic display technology has an advantage in that it can display 3D images without requiring inconvenient shutter glasses. The autostereoscopic display technology can include a parallax barrier 3D display device and a lenticular 3D display device. The parallax barrier 3D display device includes a display panel, which has pixels arranged in rows and columns, and a parallax barrier having openings of a vertical lattice shape installed in front of the display panel. The parallax barrier separates left and right images for left and right eyes of the observer, respectively, and generates binocular disparity of different images on the display panel. This type of display device has a drawback in that diffraction interference occurs through the lattice openings. Therefore, an autostereoscopic display device employs a lenticular 3D display device or a lenticular 3D system. Instead of the vertical lattice-shaped parallax barrier, the lenticular 3D system commonly uses a lenticular lens sheet, which has column-direction arrangement of semi-cylindrical lenses placed on the display panel, for 3D display. A 2D/3D switchable lenticular 3D system includes a lenticular lens sheet, a flat-surfaced plate facing it, liquid crystals filling the space between them, and electrodes formed inside the lenticular lens sheet and the flat-surfaced plate.

The lenticular device is installed in front of the display panel and is adapted to switch between 2D and 3D display modes according to turning on and off of the voltage applied between the electrodes.

In the 2D display mode, according to whether a voltage is applied across the liquid crystal materials, the refractive index of the liquid crystals in the viewing direction is substantially identical to that of the material used for the sheet, so that the lens action of the lenticular device ceases, and the lenticular system acts as a light transmitter on the display panel (i.e., having no effect on the path of light coming from the display panel).

In the 3D display mode, according to whether a voltage is applied across the liquid crystal materials, the orientation of liquid crystals makes the refractive index of the liquid crystals different from that of the material used for the sheet, so that the lenticular device acts as a lens, thereby providing the observer's left and right eyes with different images (i.e., creating the illusion of 3D images).

The resolution of liquid crystal display panels is increasing over time and in proportion to developments in relevant technology. In the case of a liquid crystal display panel upgraded by reducing the horizontal and vertical sizes of each pixel by half, the area of each pixel becomes a quarter of that before the upgrade. Such an upgrade of resolution of a liquid crystal display panel degrades the pixel aperture ratio, resulting in degradation of the display panel's luminance.

In an attempt to compensate for such degradation of luminance, the luminance of a backlight source, which illuminates the rear surface of the display panel, may be increased. This approach, however, increases power consumption and is thereby undesirable.

In the case of an autostereoscopic 3D or 2D/3D display device, the observer's viewpoint of watching 3D images may be fixed, making it crucial to increasing it to multiple viewpoints.

Therefore, there is a need for a pixel arrangement of a display panel used for a lenticular system employing, instead of sub-pixels of basic colors of red, green, and blue, basic sub-pixels of red, green, blue, and white (i.e. four sub-pixels), in order to compensate for luminance degradation.

There is also a need for a multi-viewpoint 3D display device adopting a pixel arrangement using four basic sub-pixels in line with technological developments that increase of the resolution of the display panel.

### SUMMARY

Exemplary embodiments of the present invention provide a display device having a pixel arrangement for a 3D or a 2D/3D display which can compensate for luminance degradation without increasing power consumption.

Exemplary embodiments of the present invention also provide pixel arrangement capable of increasing the number of multiple viewpoints.

Additional features of the invention will be set forth in the description which follows, and in part will be apparent from the description, or may be learned by practice of the invention.

An exemplary embodiment of the present invention discloses an autostereoscopic 3D display apparatus including a display panel having an array of pixels arranged in rows and columns, the pixels including basic pixels having four basic colors; and a lenticular device positioned above the display panel, the lenticular device including an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths of each pixel. When n is 0 or a natural number, the number of viewpoints is 2m(2n+1), and pixels corresponding to the given viewpoints are repeated at every m rows in each lenticular component, the number of parallel lines extending through centers of pixels in parallel with the slant line inside each lenticular component is identical to the number of viewpoints, and each of the parallel lines lies on the repeated basic pixels.

An exemplary embodiment of the present invention also discloses an autostereoscopic 3D display apparatus including a display panel having an array of pixels arranged in rows and columns, the pixels arranged at the odd-numbered rows being basic pixels of four colors arranged repeatedly, the pixels arranged at the even-numbered rows being aligned under the pixels arranged at each odd-numbered row starting from the third pixel; and a lenticular device positioned above the display panel, the lenticular device including an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths of each pixel. When n is 0 or a natural number, the number of viewpoints is 2m(2n+1), pixels corresponding to the given viewpoints are repeated at every m rows in each lenticular component, the number of parallel lines extending through centers of pixels in parallel with the slant line inside each lenticular component is identical to the number of viewpoints, and each of the parallel lines lies on the repeated basic pixels.

An exemplary embodiment of the present invention further discloses an autostereoscopic 3D display apparatus including a display panel having an array of pixels arranged in rows and columns, the pixels arranged at the rows being repeatedly arranged basic pixels of four colors; and a lenticular device positioned above the display panel, the lenticular device comprising an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths of each pixel. When n is 0 or a natural number, the number of viewpoints is 2m(2n+1), pixels corresponding to the given viewpoints are repeated at every m rows in each lenticular component, the number of parallel lines extending through centers of pixels in parallel with the slant line inside each lenticular component is identical to the number of viewpoints, and each of the parallel lines lies on the repeated basic pixels.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic perspective view of a liquid crystal display device according to an exemplary embodiment of the present invention.

FIG. 2 illustrates a multi-viewpoint 3D display according to an exemplary embodiment of the present invention.

FIG. 3 illustrates a relationship between the slant angle of lenticular components and the number of viewpoints according to an exemplary embodiment of the present invention;

FIG. 4 is a magnified schematic arrangement of pixels, which have viewpoints, within each lenticular component according to an exemplary embodiment of the present invention.

FIG. 5A, FIG. 5B, FIG. 5C, FIG. 6A, FIG. 6B, FIG. 6C, FIG. 7A, FIG. 7B, FIG. 8A, FIG, 8B, FIG. 8C, FIG. 8D, and FIG. 8E are magnified schematic arrangements of various basic pixels to be used for a 3D or a 2D-3D switchable display device, as well as arrangements of pixels in respective lenticular components with regard to various values of m and n.

FIG. 9A, FIG. 9B, FIG. 9C, FIG. 9D, FIG. 9E, and FIG. 9F illustrate various basic pixel arrangements for implementing an exemplary embodiment of the present invention in display panels of the same size.

FIG. 10 is a table illustrating a resolution comparison with regard to various basic pixel arrangements shown in FIG. 8.

### DETAILED DESCRIPTION OF THE ILLUSTRATED EMBODIMENTS

The invention is described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of pixels and the arrangement of pixels may be exaggerated for clarity. Like reference numerals in the drawings denote like elements.

It will be understood that the term “basic colors” refers to red, green, blue, and white, but the color of white can be replaced with one of yellow, cyan, and magenta. Pixels generally include sub-pixels of basic colors, but it will be assumed for convenience of description of the present invention that red, green, blue, and white sub-pixels are defined as pixels, respectively. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

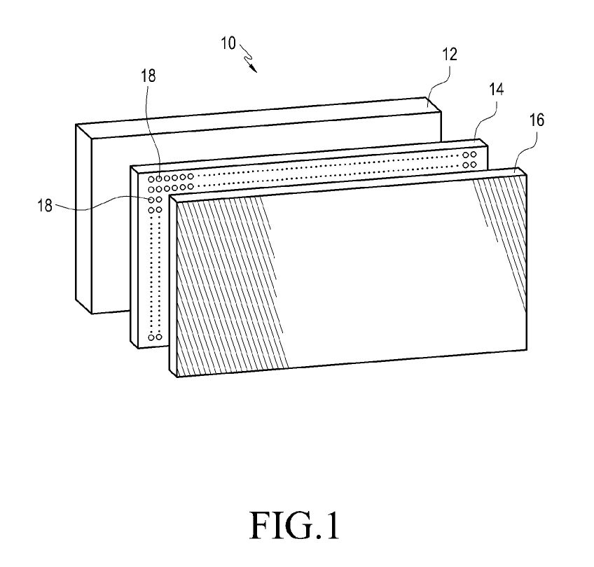

FIG. 1 is a schematic exploded perspective view of a liquid crystal display device according to an exemplary embodiment of the present invention.

Referring to FIG. 1, the 3D display device 10 includes a backlight source 12, a display panel 14, and a lenticular device 16. As the backlight source 12, a light source such as a LED (Light Emitting Diode) or a fluorescent lamp can be used. The display panel 14 may include any one of many types of display technologies, including, for example, a liquid crystal display, and includes pixels arranged in rows and columns in perpendicular directions. The liquid crystal display panel 14 includes two transparent plates spaced from each other in parallel with each other; transparent electrodes formed on the rear of the two plates and connected to drains of TFTs; a common electrode formed on the front plate; red, green, blue, and white filters formed on the common electrode so as to face the transparent electrodes; and liquid crystals filling the space between the two plates. The gates and drains of the TFTs formed on the plate are connected to gate and data lines associated with corresponding rows and columns, so that respective TFTs can be accessed or addressed. The pixels 18 are arranged in the shape of a matrix having perpendicular rows and columns, and are shown to have gaps. However, such a matrix shape and gaps are not mandatory, and the pixels are not necessarily circular or quadrangular. The lenticular device 16 can be a lenticular sheet solely adapted to 3D display.

When a display device 10 capable of switching from 3D to 2D is needed, the lenticular device 16 may include a lenticular lens sheet, a flat-surfaced plate facing it, liquid crystals filling the space between them, and electrodes formed within the lenticular lens sheet 16 and the flat-surfaced plate 162.

The display panel 14 receives light from the backlight source 12; the light is incident through a rear plate (not shown) of the display panel 14; and images modulated by pixels driven by signals on gate and data lines are outputted through the display panel 14. The images outputted through the lenticular device 16, which is fastened to the display panel 14, are provided as different images for the left and right eyes of the observer such that, in the case of 3D, autostereoscopic 3D display is possible.

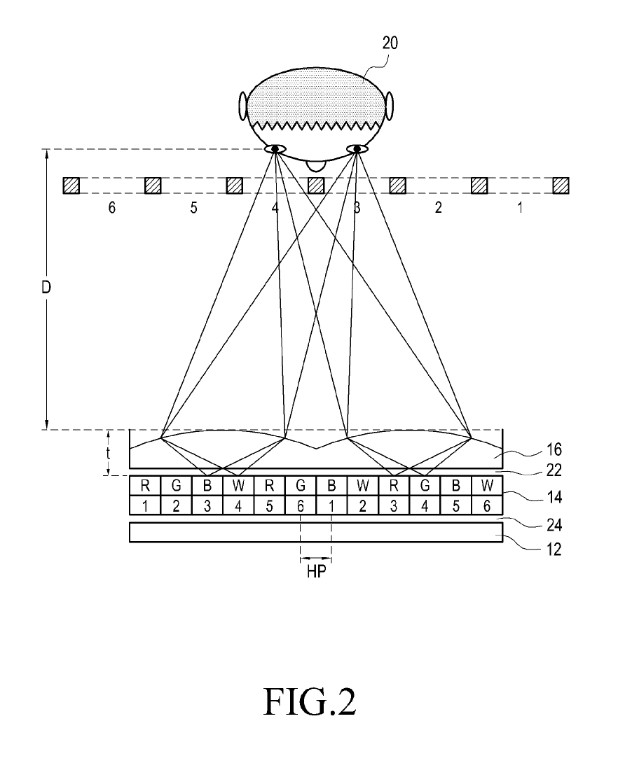

FIG. 2 illustrates a multi-viewpoint 3D display according to an exemplary embodiment of the present invention. FIG. 2 is a schematic sectional view of a 3D display device in connection with two lenticular components for convenience of description and illustration. It will be assumed for convenience of description that the display panel 14 has repetitive groupings of R, G, B, and W pixels, and corresponding viewpoint positions.

Referring to FIG. 2, six viewpoints are provided, and the observer 20 is shown watching the display device at viewpoint positions 3 and 4. As shown, the right eye of the observer 20 is watching pixels R and B corresponding to viewpoint position 3, while the left eye is watching G and W corresponding to viewpoint position 4. As such, the observer 20 is watching different images through respective eyes, and the resulting binocular disparity creates the illusion of 3D images.

The gap 22 between the lenticular device 16 and the display panel 14 may be filled with an adhesive for fastening them together. The adhesive may be optically transparent so that the refractive index of the adhesive does not differ from that of the material of the adhesive layers of the lenticular device 16 and the display panel 14, i.e., glass layers. The gap 24 between the backlight source 12 and the rear surface of the display panel 14 may also be filled with an optically transparent adhesive.

The distance between the surface of the lenticular device 16 and the observer's eyes, i.e., the distance of distinct vision D, can be determined by the designer. The distance between the minimums and the surface of the lenticular device 16, i.e., the stack thickness t, can be the sum of thicknesses of the front glass plate of the display device 14, the adhesive layer of the gap 22, and the lenticular device 16. The stack thickness is typically given: t=n·(D/g), where g refers to the magnification of lenticular components. As described above, the refractive indices of the front glass plate of the display device 14, the adhesive of the gap 22, and the lenticular device 16 may be the same as the refractive index of glass, 1.52. Therefore, the stack thickness t is inversely proportional to the magnification g of lenticular components, and the larger the magnification g becomes, the smaller the stack thickness t becomes. When ES is the interpupillary distance of the observer, and HP is a pixel horizontal period between pixels, the magnification g is given as ES/HP. Considering that the interpupillary distance ES is typically set in the range of 62-65 mm, the pixel horizontal period HP may need to be reduced to increase the magnification. The HP can be reduced by increasing the number of viewpoints according to characteristics of the present invention, as will be described later.

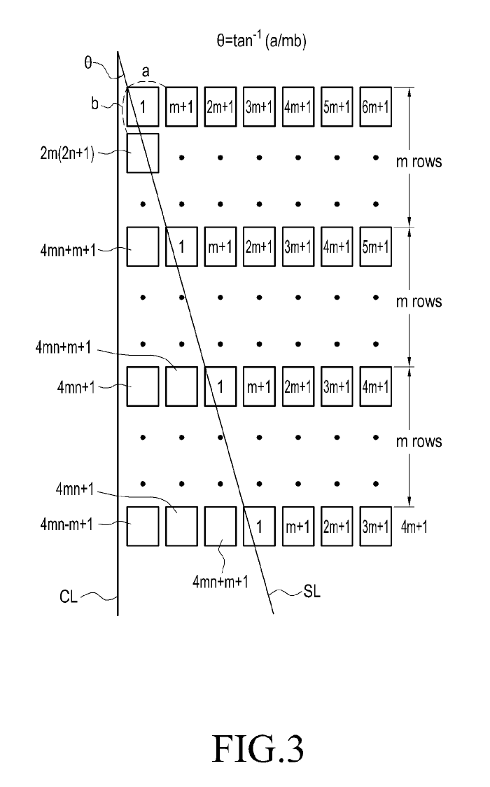

FIG. 3 illustrates the relationship between the slant angle of lenticular components and the number of viewpoints according to an exemplary embodiment of the present invention.

Referring to FIG. 3, a slant line SL is shown at an angle θ with regard to a column line CL, which is parallel to a plurality of columns of pixels. Assuming that a and b are the horizontal and vertical lengths of each pixel, respectively, and m is the number of adjacent rows, the slant angle θ is given as tan⁻¹(a/mb). The number of viewpoints is then 2m(2n+1), wherein n is 0 or a natural number.

The slant line SL extends through upper left vertices of a pixel at the first row and the first column, a pixel at the (m+1)^{th} row and the second column, a pixel at the (2m+1)^{th} row and the third column, and a pixel at the (3m+1)^{th} row and the fourth column, respectively, and all of these pixels correspond to the first viewpoint (labeled “1”). Pixels at rows right next to the rows of pixels having viewpoint 1 and the same columns correspond to the last viewpoint, i.e., 2m(2n+1). That is, at the same column, a pixel at a row next to a pixel having viewpoint 1 has viewpoint 2m(2n+1); and, as the number of rows increases, the viewpoint decreases by 1 until a pixel of viewpoint 1 appears. Therefore, at the same column, pixels at rows above a pixel having viewpoint 1 are increased by 1. In addition, at the same row, pixels successively increasing in the column direction from a pixel having viewpoint 1 increase by m until 4mn+m+1, which is the viewpoint of a pixel at a column right before the next pixel of viewpoint 1. Appearance of the next pixel of viewpoint 1 means, as will be described later, appearance of the next lenticular component.

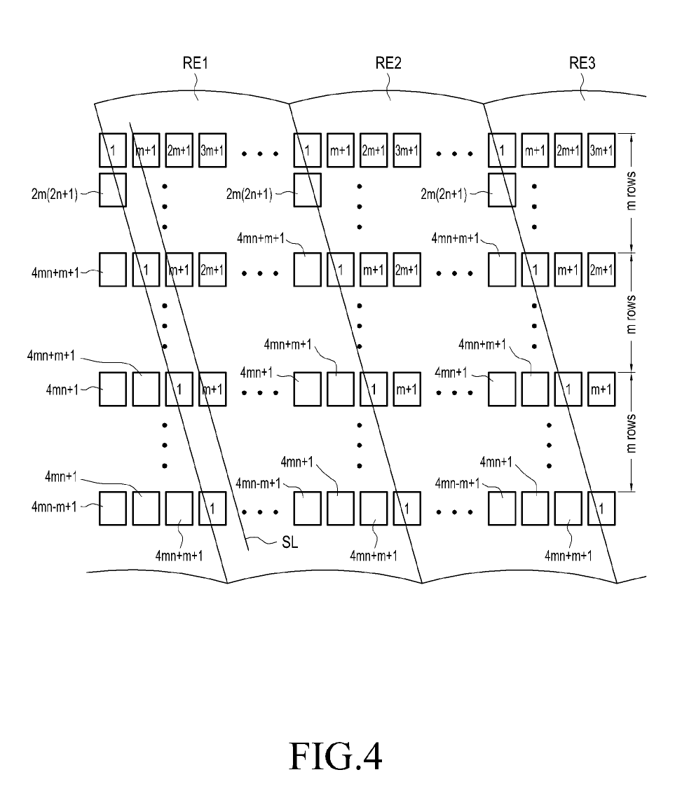

FIG. 4 is a magnified schematic arrangement of pixels, which have viewpoints, within respective lenticular components according to an exemplary embodiment of the present invention.

As shown in FIG. 4, lenticular components RE1-RE3 are semi-cylindrical lenticulars elongated in parallel with the slant line SL. Centers of pixels representing the same viewpoints are on the same line parallel with the slant line SL. Furthermore, lines parallel with the slant line SL, which extend through centers of pixels having viewpoints increasing from 1 to 2m(2n+1), have a pixel horizontal period HP, as shown in FIG. 2, and are arranged in the same lenticular component in the order of the number of viewpoints. Therefore, the pixel horizontal period HP decreases as the number of viewpoints increases, and thus the magnification g of lenticular components increases. Consequently, the stack thickness t decreases.

It is clear from FIG. 4 that, within respective lenticular components RE1-RE3, as many as 2m(2n+1) viewpoints are repeatedly arranged at every m adjacent row.

In order to display 3D colors, in the case of pixels having the same viewpoints, red, green, blue, and white pixels may be arranged repeatedly. However, red, green, blue, and white pixels need not be arranged repeatedly in that order.

Within respective lenticular components, the number of pixels in each row is 2m(2n+1).

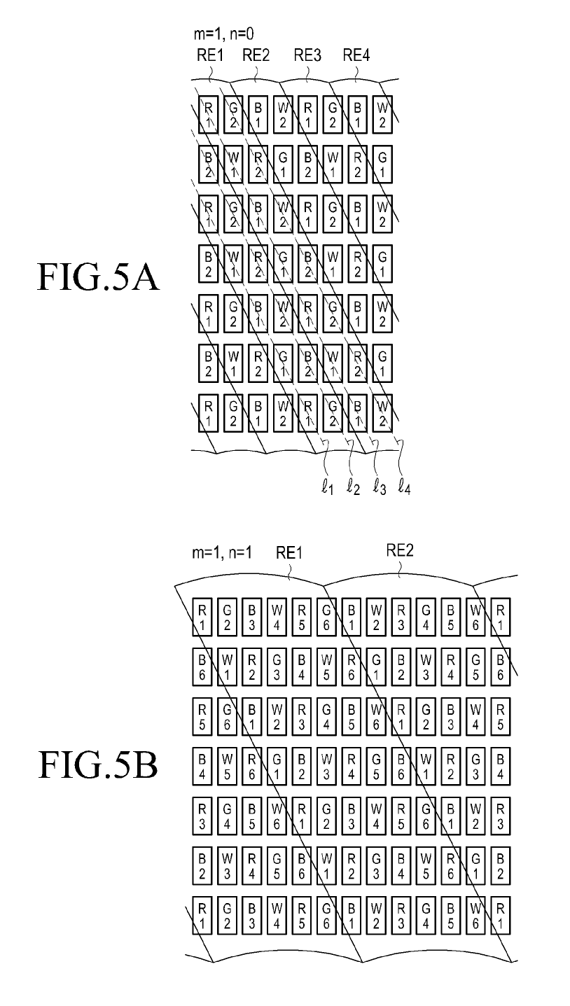

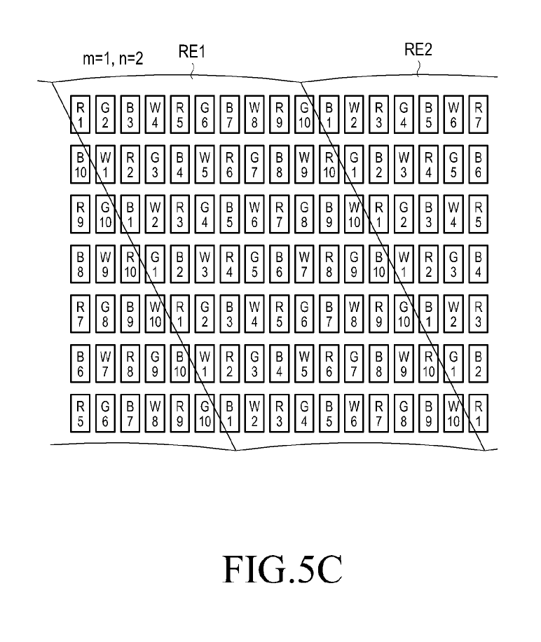

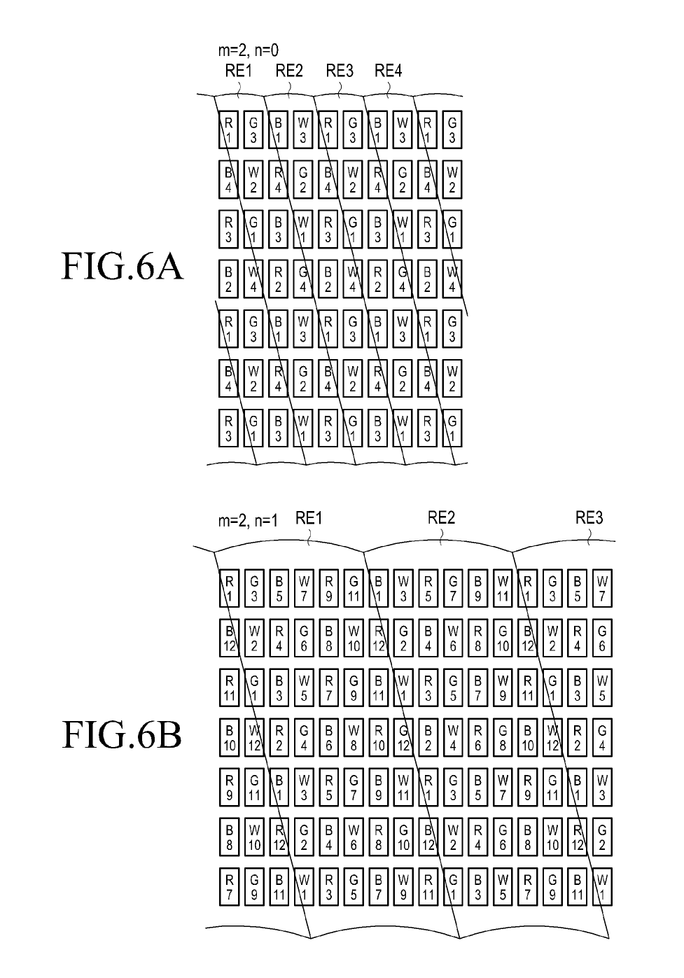

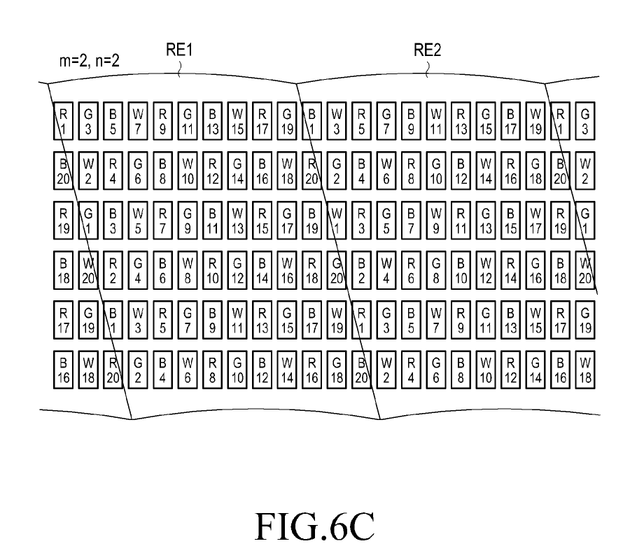

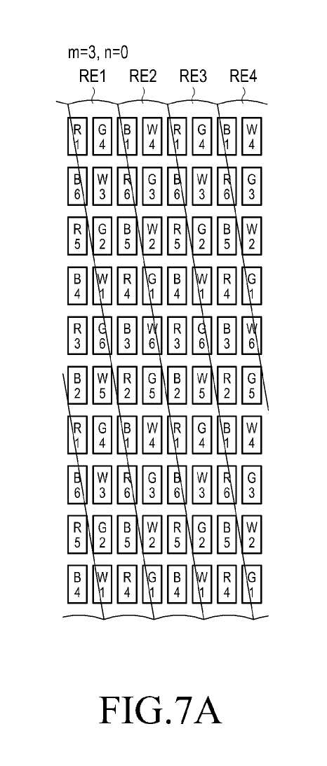

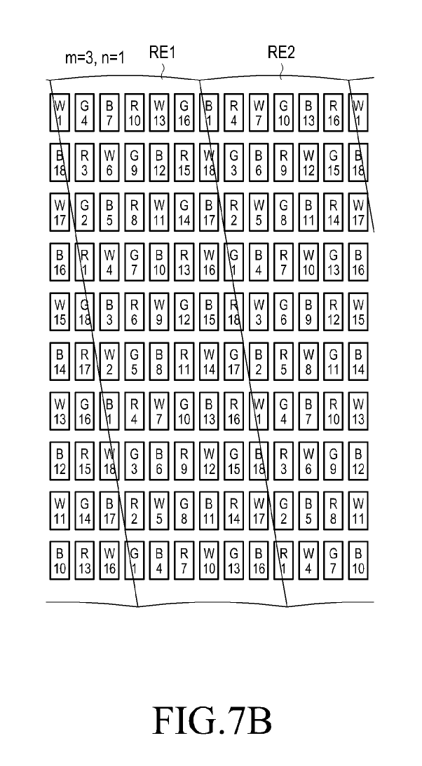

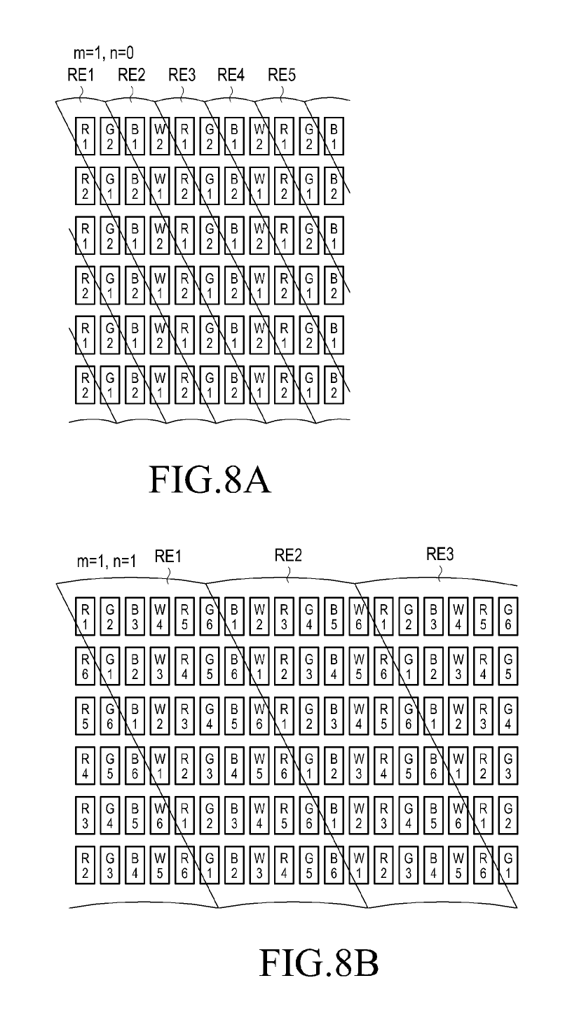

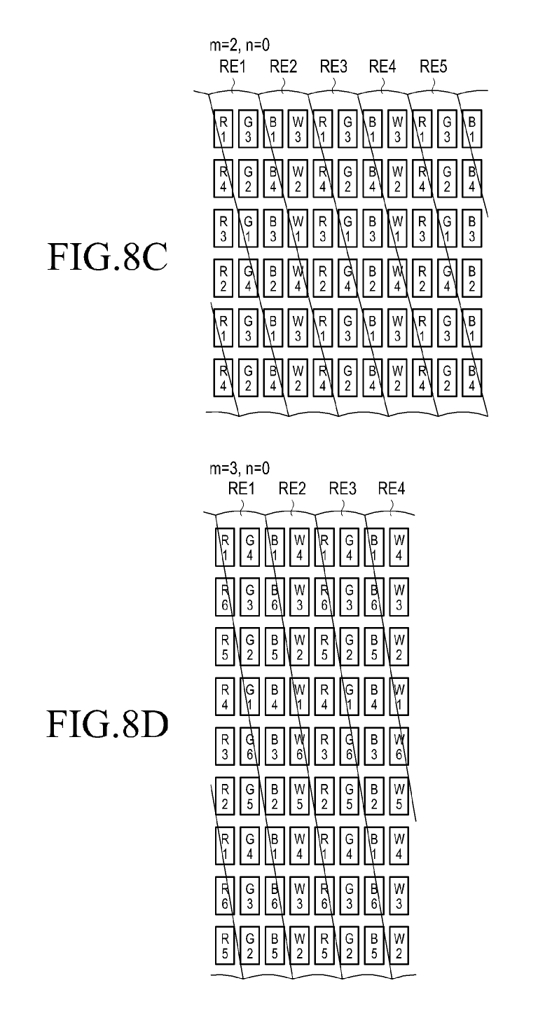

FIGS. 5A-8Ee schematically magnify the arrangement of pixels, with regard to various values of m and n, within respective lenticular components for a 3D or 2D-3D switchable color display.

FIG. 5A illustrates pixels arranged below lenticular components RE1-RE4 when m=1, n=0, and the number of viewpoints 2m(2n+1) becomes 2. At odd-numbered rows, basic pixels of red (R), green (G), blue (B), and white (W) are arranged repeatedly and, at even-numbered rows, pixels are arranged in the same order as the pixels of each odd-number row, starting at the third and continuing in the following columns. That is, when each odd-numbered row has an arrangement of pixels R, G, B, W, R, G, B, W, . . . as shown, each even-numbered row has an arrangement of pixels starting from the third pixel in the row above it, i.e., B, W, R, G, B, W, . . . . A line l1 extending through the centers of pixels having viewpoint 1 and a line l2 extending through the centers of pixels having viewpoint 2 are positioned within the same lenticular components at the same distance and in parallel with them. Since m=1, viewpoints are arranged at each row within each lenticular component.

FIG. 5B illustrates pixels having viewpoint numbers when m=1 and n=1, which are the same as the pixels shown in FIG. 5A, except that the number of viewpoints is 6.

FIG. 5C is the same as FIGS. 5A and 5B, except that m=1, n=2, and the number of viewpoints is 10.

FIGS. 6A-6C illustrate an arrangement of pixels and lenticular components RE1-RE4 when m=2. In FIGS. 6A-6C, within each lenticular component, viewpoints are repeatedly arranged every two rows. Otherwise, the arrangement is the same as described above.

FIGS. 7A and 7B illustrate an arrangement of pixels and lenticular components RE1-RE4 when m=3. In FIGS. 7A and 7B, within each lenticular component, viewpoints are repeatedly arranged every three rows. Otherwise, the arrangement is the same as described above. It is clear from FIG. 7B that arrangements other than the arrangement of colors of R, G, B, and W is also possible. That is, when odd-numbered rows have repetition of W, G, B, and R, which is a modification of the arrangement of R, G, B, and W, the arrangement of pixels at even-numbered rows is a repetition of B, R, W, and G, which is the successive arrangement starting from the third column of each odd-numbered row.

FIGS. 8A-8E illustrate an arrangement of pixels of each row, which is a repeated arrangement of basic pixels of R, G, B, and W. Therefore, each identical column has an arrangement of pixels of the same color. Otherwise, the arrangement is the same as described above.

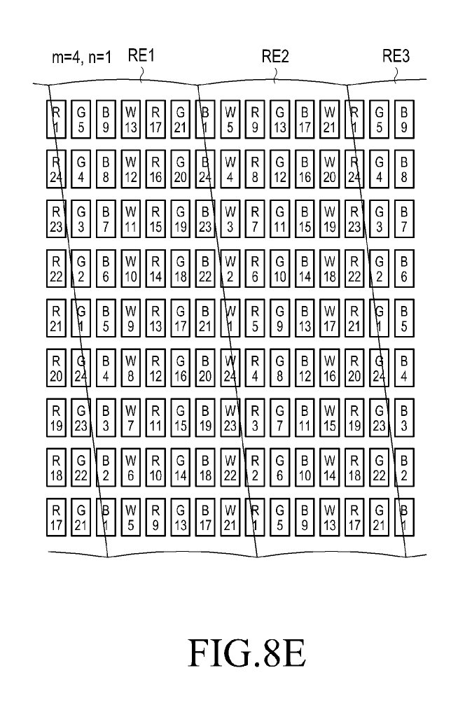

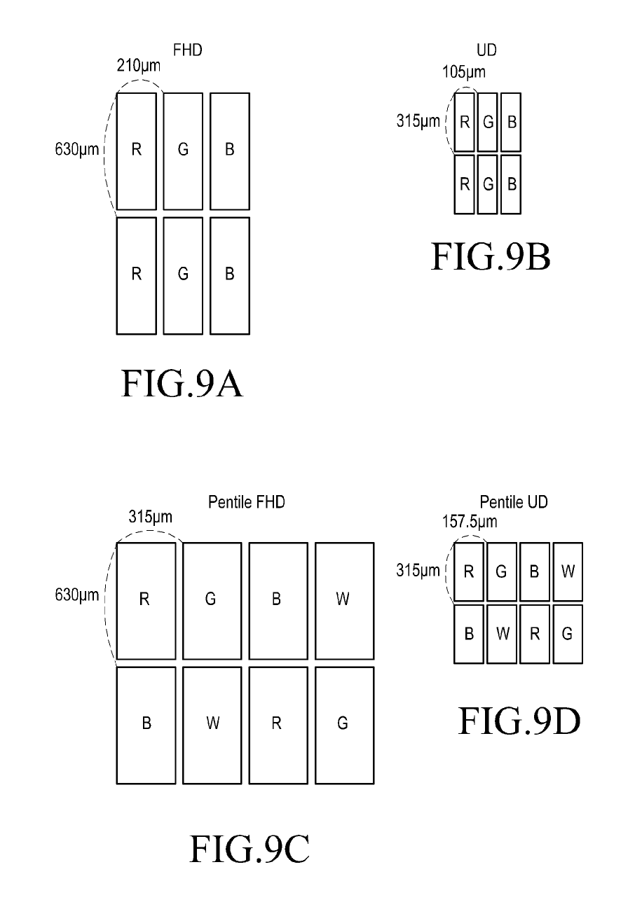

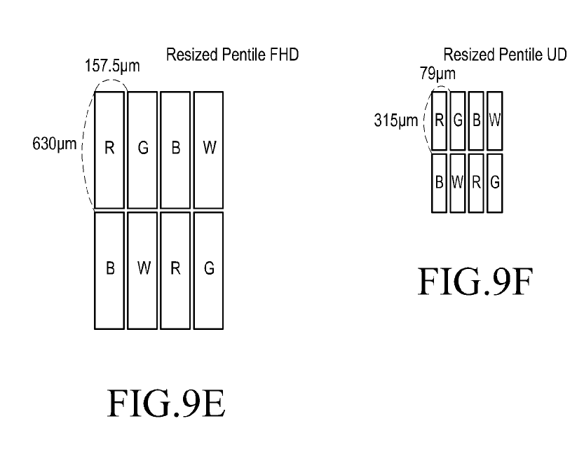

FIGS. 9A-9B illustrate various basic pixel arrangements for implementing an exemplary embodiment of the present invention for display panels of the same size, e.g., 55 inches.

FIG. 9A illustrates conventional basic pixels of FHD (Full High Definition) having 2D resolution of 1920×1080 and a pixel size of 210 μm×630 μm.

FIG. 9B illustrates RGB basic pixels of UD (Ultra Definition) having 2D resolution of 3840×2160, which is the next generation of FHD. The basic pixel of UD has horizontal and vertical sizes half those of the basic pixel of FHD.

FIG. 9C illustrates basic pixels of FHD having a pixel size of 315 μm×630 μm. FIG. 9D illustrates UD basic pixels obtained by reducing the size of the basic pixels of FHD shown in FIG. 9C to ¼ to be used for UD.

FIG. 9E illustrate basic pixels of FHD obtained by reducing the horizontal size of the basic pixels of FHD shown in FIG. 9C by half. FIG. 9F illustrate basic pixels of UD obtained by reducing the size of the reduced basic pixels of FHD, which are shown in FIG. 9E, to ¼ to be used for UD. All of these basic pixels can switch between 2D and 3D.

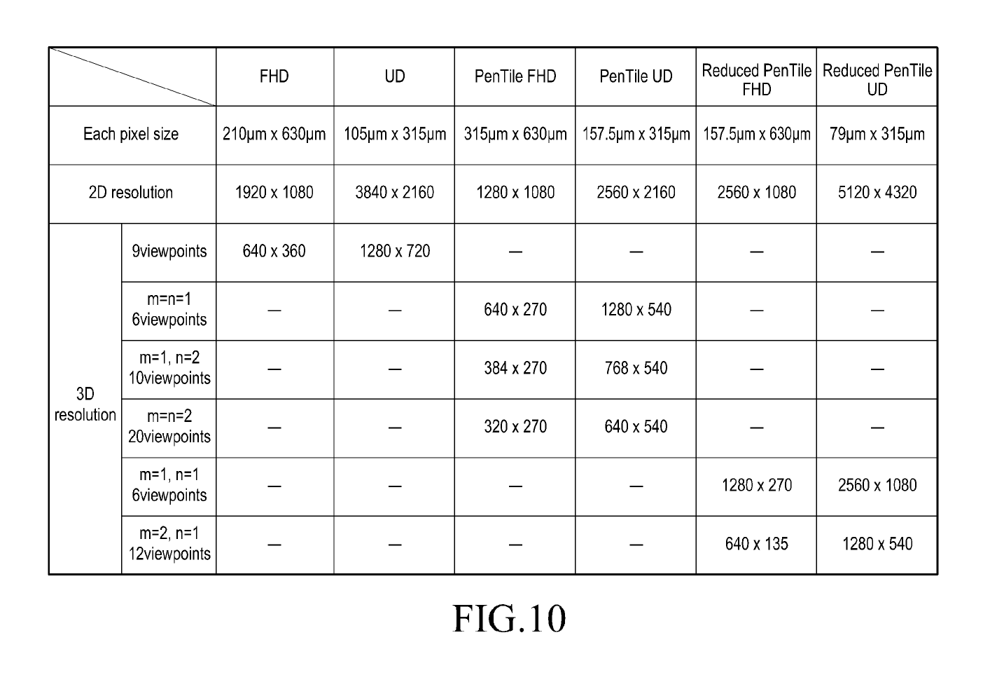

FIG. 10 shows respective resolutions when various basic pixels shown in FIG. 9 are used for display panels of the same size of 55 inches. It is clear from FIG. 10 that the horizontal resolution of reduced FHD and reduced UD is close to or greater than the 2D horizontal resolution of FHD.

Therefore, improvement of resolution and reduction of the stack thickness can be advantageously achieved by applying suitable values of m and n and increased numbers of viewpoints. In addition, when all RGB pixels are turned on they produce a white color and, together with W pixels, compensate for luminance degradation.

When m doubles, the number of viewpoints also doubles, and the magnification doubles accordingly, as described above. This makes it possible to reduce the stack thickness to half, thereby resulting in the manufacture of a thin and light display panel.

It will be obvious to those skilled in the art that, although the present invention has been described with regard to a LCD display panel, the present invention is also applicable to other types of display panels, such as CRT, PDP, OLED, and FED.

The present invention produces the following advantage: on a display panel having an array of rows and columns of pixels having basic PenTile colors, the lenticular device has an array of a plurality of lenticular components extending in parallel with a slant line having an angle of tan⁻¹(a/mb) with regard to the columns, and the number of viewpoints is 2m(2n+1), so that an increase of the number of viewpoints can be adjusted properly according to increase of resolution of pixels of display panels in line with the demands of the time and development of relevant technologies. Furthermore, it is possible to obtain high luminance of display panels, as the pixel aperture ratio decreases, without a resulting increase in the power consumption of the backlight source.

In this case, a and b refer to the horizontal and vertical sizes of each pixel, m refers to the number of adjacent rows, and n is 0 or a natural number. Proper selection of m can reduce the stack thickness, including the thickness of the lenticular device, and thus realize a thin and light 3D display device.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An autostereoscopic 3D display apparatus comprising:
a display panel comprising an array of pixels arranged in rows and columns, the pixels arranged at the odd-numbered rows being basic pixels of four colors arranged repeatedly, the pixels arranged at the even-numbered rows being the pixels arranged at each odd-numbered row starting from the third pixel; and
a lenticular device disposed in front of the display panel, the lenticular device comprising an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths, respectively, of each pixel, wherein
when n is 0 or a natural number, the number of viewpoints is 2m(2n+1), pixels corresponding to the given viewpoints are repeated at every m row in each lenticular component, the number of parallel lines extending through pixels in parallel with the slant line within each lenticular component is identical to the number of viewpoints, and each of the parallel lines lies on the repeated basic pixels.

2. The autostereoscopic 3D display apparatus as claimed in claim 1, wherein the four colors comprise red, green, blue, and one of yellow, cyan, and magenta.

3. The autostereoscopic 3D display apparatus as claimed in claim 1, wherein the number of viewpoints is increased by an increase of m according to an increase of resolution of the pixels of the display panel.

4. The autostereoscopic 3D display apparatus as claimed in claim 1, wherein the lenticular device comprises a transparent lenticular lens sheet, a transparent flat plate, transparent electrodes formed within the lenticular lens sheet and the flat plate, respectively, and a medium positioned between the transparent electrodes.

5. The autostereoscopic 3D display apparatus as claimed in claim 4, wherein the medium comprises liquid crystals.

6. An autostereoscopic 3D display apparatus comprising:
a display panel comprising an array of pixels arranged in rows and columns, the pixels arranged at the rows comprising repeatedly arranged basic pixels of four colors; and
a lenticular device disposed in front of the display panel, the lenticular device comprising an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths, respectively, of each pixel, wherein
when n is 0 or a natural number, the number of viewpoints is 2m(2n+1), pixels corresponding to the given viewpoints are repeated at every m row in each lenticular component, the number of parallel lines extending through pixels in parallel with the slant line within each lenticular component is identical to the number of viewpoints, and each of the parallel lines lies on the repeated basic pixels.

7. The autostereoscopic 3D display apparatus as claimed in claim 6, wherein the four colors comprise red, green, blue, and one of yellow, cyan, and magenta.

8. The autostereoscopic 3D display apparatus as claimed in claim 6, wherein the number of viewpoints is increased by an increase of m according to an increase of resolution of the pixels of the display panel.

9. The autostereoscopic 3D display apparatus as claimed in claim 6, wherein the lenticular device comprises a transparent lenticular lens sheet, a transparent flat plate, transparent electrodes formed within the lenticular lens sheet and the flat plate, respectively, and a medium positioned between the transparent electrodes.

10. The autostereoscopic 3D display apparatus as claimed in claim 9, wherein the medium comprises liquid crystals.

11. An autostereoscopic 3D display apparatus comprising:
a display panel comprising an array of pixels arranged in rows and columns, the pixels comprising basic pixels of four basic colors; and
a lenticular device disposed in front of the display panel, the lenticular device comprising an array of a plurality of lenticular components extending in parallel with a slant line slanted at an angle of tan⁻¹(a/mb) with regard to columns of the pixels, where m refers to the number of adjacent rows before an identical viewpoint on the same slant line appears, and a and b refer to horizontal and vertical lengths, respectively, of each pixel, wherein
when n is 0 or a natural number, the number of viewpoints is 2m(2n+1), pixels corresponding to the given viewpoints are repeated at every m rows in each lenticular component, the number of parallel lines extending through pixels in parallel with the slant line inside each lenticular component is identical to the number of viewpoints, and each of the parallel lines lies on the repeated basic pixels.

12. The autostereoscopic 3D display apparatus as claimed in claim 11, wherein the basic pixels are repeatedly arranged at the odd-numbered rows, and the basic pixels arranged at the even-numbered rows are the basic pixels arranged at each odd-numbered row starting from the third pixel.

13. The autostereoscopic 3D display apparatus as claimed in claim 12, wherein the four colors comprise red, green, blue, and one of yellow, cyan, and magenta.

14. The autostereoscopic 3D display apparatus as claimed in claim 11, wherein the basic pixels arranged at respective rows are red, green, blue, and one of white, yellow, cyan, and magenta pixels arranged repeatedly.

15. The autostereoscopic 3D display apparatus as claimed in claim 14, wherein the pixels arranged at respective rows are red, green, blue, and one of yellow, cyan, and magenta.

16. The autostereoscopic 3D display apparatus as claimed in claim 12, wherein the lenticular device comprises a transparent lenticular lens sheet, a transparent flat plate, transparent electrodes formed within the lenticular lens sheet and the flat plate, respectively, and a medium positioned between the transparent electrodes.

17. The autostereoscopic 3D display apparatus as claimed in claim 16, wherein the medium comprises liquid crystals.

18. The autostereoscopic 3D display apparatus as claimed in claim 14, wherein the lenticular device comprises a transparent lenticular lens sheet, a transparent flat plate, transparent electrodes formed within the lenticular lens sheet and the flat plate, respectively, and a medium positioned between the transparent electrodes.

19. The autostereoscopic 3D display apparatus as claimed in claim 18, wherein the pixels arranged at respective rows are red, green, blue, and one of yellow, cyan, and magenta.

20. The autostereoscopic 3D display apparatus as claimed in claim 19, wherein the medium comprises liquid crystals.

21. The autostereoscopic 3D display apparatus as claimed in claim 20, wherein the number of viewpoints is increased by an increase of m according to an increase of resolution of the pixels of the display panel.
